(19) United States
(12) Patent Application Publication
(10) Pub. No.: US 2020/0074676 A1
(43) Pub. Date: Mar. 5, 2020

(54) MANAGEMENT SYSTEM, STORAGE MEDIUM, POSITION CALCULATION METHOD, AND MANAGEMENT APPARATUS

(71) Applicant: FUJITSU LIMITED, Kawasaki-shi (JP)

(72) Inventors: Ryutaro Nomasa, Shinagawa (JP); Masami Chino, Chino (JP); Kenichiro TAKEBE, Yokohama (JP)

(73) Assignee: FUJITSU LIMITED, Kawasaki-shi (JP)

(21) Appl. No.: 16/546,700

(22) Filed: Aug. 21, 2019

(30) Foreign Application Priority Data
Aug. 31, 2018 (JP) 2018-163505

(51) Int. Cl. G06T 7/73; G06K 9/00

(52) U.S. Cl. CPC G06T 7/74; G06K 9/00791; G06K 2209/15; G06T 2207/30252; G06T 2207/30204

(57) ABSTRACT

A management system includes a management apparatus, and an imaging device which is attached to a mobile object moving inside a building and which is coupled to the management apparatus, wherein the management apparatus acquires a captured image which the imaging device attached to the mobile object obtains by photographing at least three targets installed on a ceiling of the building and arranged at known distances from each other, and calculates a position of the mobile object to which the imaging device is attached based on positions of the targets in the captured image and the distances between the targets.

### CROSS-REFERENCE TO RELATED APPLICATION

This application is based upon and claims the benefit of priority of the prior Japanese Patent Application No. 2018-163505, filed on Aug. 31, 2018, the entire contents of which are incorporated herein by reference.

### FIELD

The embodiments discuss herein relate to a management system, a storage medium, a position calculation method, and a management apparatus.

### BACKGROUND

Heretofore, a management system has been known which calculates the position of a mobile object moving in a building and manages the position of the mobile object. Use of the management system makes it possible to, for example, manage the position of each mobile object (for example, a forklift) which transports an item in a building such as a factory or a warehouse, and make an inventory management of items and the like.

For example, related arts are disclosed in Japanese Laid-open Patent Publication No. 2006-111415 and so on.

In this regard, in an environment where the Global Positioning System (GPS) is unusable like the inside of a building, the position of a mobile object is calculated by using a millilaser, a beacon, or the like.

The millilaser, however, is incapable of calculating three-dimensional coordinates, and therefore is inadequate for an environment where items are stacked up in multiple layers. Meanwhile, use of a beacon to calculate the three dimensional coordinates with high accuracy has a problem of high cost because a large number of beacon generators have to be installed.

In view of the above circumstances, it is desirable to improve the calculation accuracy in calculating the position of a mobile object moving inside a building.

### SUMMARY

According to an aspect of the embodiments, a management system includes a management apparatus, and an imaging device which is attached to a mobile object moving inside a building and which is coupled to the management apparatus, wherein the management apparatus acquires a captured image which the imaging device attached to the mobile object obtains by photographing at least three targets installed on a ceiling of the building and arranged at known distances from each other, and calculates a position of the mobile object to which the imaging device is attached based on positions of the targets in the captured image and the distances between the targets.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating one example of a system configuration of a management system;

FIG. 2 is a diagram illustrating an application example of the management system;

FIG. 3 is a diagram illustrating one example of management data;

FIGS. 4A and 4B are sequence diagrams illustrating an inventory management processing sequence in the management system;

FIG. 5 is a diagram illustrating one example of a hardware configuration of a management apparatus;

FIG. 6 is a diagram illustrating one example of a functional configuration of a warehousing manager in the management apparatus;

FIG. 7 is a diagram illustrating one example of a functional configuration of an inventory manager in the management apparatus;

FIG. 8 is a first diagram illustrating a method of calculating three dimensional coordinates by a position calculation unit;

FIGS. 9A and 9B are second diagrams illustrating the method of calculating the three dimensional coordinates by the position calculation unit; and

FIG. 10 is a diagram illustrating another example of the system configuration of the management system.

### DESCRIPTION OF EMBODIMENTS

Hereinafter, the embodiments of the present disclosure are described with reference to the accompanying drawings. In the specification and drawings, constituent elements having substantially the same functional configuration are described with the same reference sign and the overlapping description thereof is omitted.

### First Embodiment

<System Configuration of Management System>

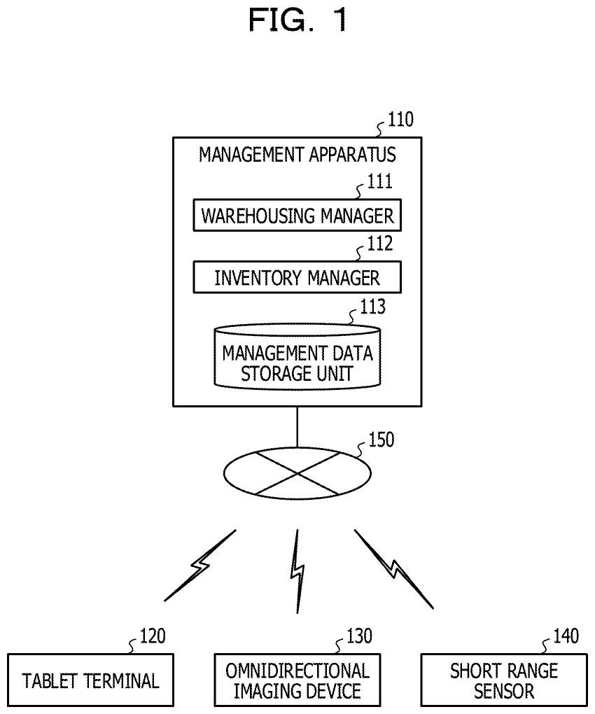

First, description is provided for a system configuration of a management system according to a first embodiment. FIG. 1 is a diagram illustrating one example of a system configuration of a management system. As illustrated in FIG. 1, a management system 100 includes a management apparatus 110, a tablet terminal 120, an omnidirectional imaging device 130, and a short range sensor 140. The management apparatus 110, the tablet terminal 120, the omnidirectional imaging device 130, and the short range sensor 140 are communicably coupled to each other via a network 150.

The management apparatus 110 is an apparatus that makes an inventory management of items and the like inside a building such as a factory or a warehouse. A warehousing management program and an inventory management program are installed in the management apparatus 110, and the management apparatus 110 functions as a warehousing manager 111 and an inventory manager 112 by running these programs.

The warehousing manager 111 communicates with the tablet terminal 120 to, for example, manage items actually delivered into the building such as the factory or the warehouse, and update management data stored in a management data storage unit 113.

The inventory manager 112 communicates with the omnidirectional imaging device 130 and the short range sensor 140 to, for example, calculate the three dimensional coordinates (hereinafter abbreviated to 3D coordinates) of a mobile object in a transport operation and a storage operation in the case where an item delivered into the building such as the factory or the warehouse is transported by the mobile object and stored into a predetermined storage place by the mobile object. Moreover, the inventory manager 112 updates the management data stored in the management data storage unit 113 by using the calculated 3D coordinates.

In this way, the inventory manager 112 is capable of managing the position of each item during transport and the storage place of each item stored even in the building where items are stacked up in multiple layers.

For example, the tablet terminal 120 checks the items delivered into the building such as the factory or the warehouse against warehousing schedule information and transmits a warehousing result to the management apparatus 110.

The omnidirectional imaging device 130 and the short range sensor 140 are attached to, for example, a mobile object which transports an item and stores it in a predetermined storage place in the building such as the factory or the warehouse. In the present embodiment, a forklift is used as the mobile object, and the omnidirectional imaging device 130 is attached to a lifting device which lifts up and down an item mounted on the forklift (for example, in the vicinity of a folk portion which moves up and down together with the item, or in the vicinity of the backrest portion). On the other hand, the short range sensor 140 is attached to a mast portion of the lifting device on the upper side of the forklift such that the short range sensor 140 is enabled to measure a mount position at which an item is mounted.

The omnidirectional imaging device 130 is an image capture that captures still images and moving images at 360° in all of the upper, lower, right, and left directions. The omnidirectional imaging device 130 captures an image of an item mounted on the forklift and transmits the captured image to the management apparatus 110. In addition, while the forklift is transporting an item, the omnidirectional imaging device 130 captures an image of markers (targets) installed on the ceiling, a side wall, or the like in the building such as the factory or the warehouse, and transmits the captured image to the management apparatus 110.

The short range sensor 140 detects that an item is mounted on the forklift, and transmits the detection result to the management apparatus 110. In addition, when an item mounted on the forklift is stored into a predetermined storage place, the short range sensor 140 detects that the mount position on the forklift becomes empty and transmits the detection result to the management apparatus 110.

<Application Example of Management System>

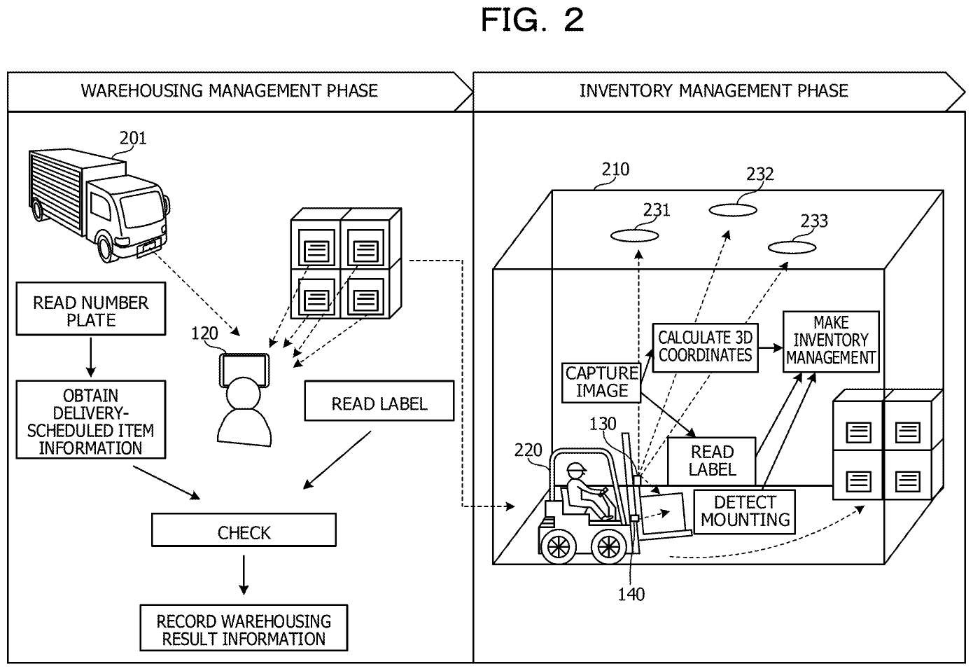

Next, a specific application example of the management system 100 is described. FIG. 2 is a diagram illustrating an application example of the management system. The example in FIG. 2 illustrates a case where the management system 100 is applied to an inventory management of items in a warehouse 210. As illustrated in FIG. 2, the inventory management of the items in the warehouse 210 is roughly divided into a warehousing management phase in which the warehousing manager 111 operates and an inventory management phase in which the inventory manager 112 operates.

In the warehousing management phase, when a truck 201 loaded with items arrives at the inside of the warehouse, a user of the tablet terminal 120 captures an image of a number plate of the truck 201 and transmits the image to the management apparatus 110 in order to identify the truck 201. In response to this, the management apparatus 110 transmits, to the tablet terminal 120, information on items scheduled to be delivered by the truck 201 (delivery-scheduled item information).

In addition, the user of the tablet terminal 120 captures images of labels attached to the items unloaded from the truck 201, and identifies each of the items. Moreover, the user of the tablet terminal 120 checks the identified items against the delivery-scheduled item information to generate warehousing result information, and transmits the warehousing result information to the management apparatus 110. Thus, the warehousing result information is recorded in the management data stored in the management data storage unit 113 of the management apparatus 110.

When the recording of the warehousing result information is completed, the inventory management transitions to the inventory management phase. In the inventory management phase, when each of the unloaded items is mounted one after another on the mount position of a forklift 220, the short range sensor 140 detects that the item is mounted and transmits the detection result to the management apparatus 110. In response to this, the omnidirectional imaging device 130 captures an image of the label of the mounted item and transmits the captured image to the management apparatus 110. As a result, the management apparatus 110 identifies the item mounted on the forklift 220 based on the captured image of the label of the item mounted.

Moreover, the omnidirectional imaging device 130 starts to capture an image of markers 231 to 233 installed on the ceiling of the warehouse 210, and transmits the captured image to the management apparatus 110. Using this captured image, the management apparatus 110 calculates a direction (angle) of each of the markers 231 to 233 with respect to the current position of the omnidirectional imaging device 130. Moreover, the management apparatus 110 calculates 3D coordinates indicating the current position of the omnidirectional imaging device 130 in the warehouse 210 based on the calculated directions of the markers 231 to 233 and the distances between the markers 231 to 233 (between the targets) (the previously-measured distance between each pair of them).

Here, the omnidirectional imaging device 130 captures the image of the markers 231 to 233 repetitively in predetermined cycles after the item is mounted on the forklift 220 until the item is stored into a predetermined storage place. Thus, the management apparatus 110 is enabled to calculate the 3D coordinates of the forklift 220, to which the omnidirectional imaging device 130 is attached, in the predetermined cycles, and thereby manage the position of the item during transport and the storage places of the stored items.

<Specific Example of Management Data>

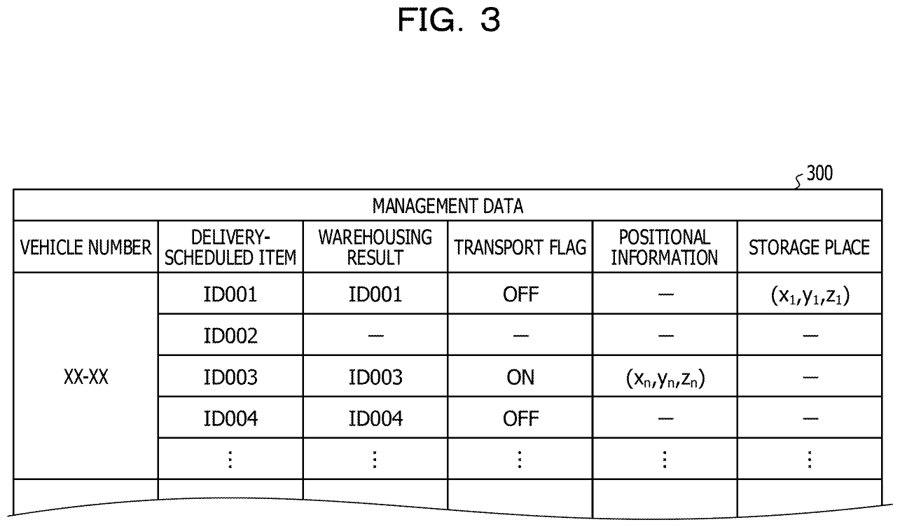

Next, description is provided for a specific example of the management data stored in the management data storage unit 113 of the management apparatus 110. FIG. 3 is a diagram illustrating one example of management data. As illustrated in FIG. 3, management data 300 contains data items including “vehicle number”, “delivery-scheduled item”, “transport flag”, “positional information”, and “storage place”.

In the “vehicle number”, a vehicle number of the truck 201 loaded with items scheduled to be delivered into the warehouse 210 is recorded. FIG. 3 gives the example where the truck 201 with the vehicle number=“XX-XX” is scheduled to arrive at the warehouse 210 with delivery-scheduled items loaded on the truck 201.

In the “delivery-scheduled item”, an identifier identifying each of items scheduled to be loaded on and delivered by the truck 201 with the associated “vehicle number” is recorded. FIG. 3 gives the example where the items identified with the identifiers=ID001, ID002, ID003, ID004, . . . are scheduled to be loaded on and delivered by the truck 201 with the vehicle number=“XX-XX”.

In the “warehousing result”, an identifier identifying an item actually unloaded from the truck 201 and delivered into the warehouse 210 is recorded. FIG. 3 gives the example where the items identified with the identifiers=ID001, ID003, ID004, . . . are actually delivered among the delivery-scheduled items. In addition, FIG. 3 gives the example where the item identified with the identifier=ID002 is not actually delivered among the delivery-scheduled items.

In the “transport flag”, “ON” is recorded in the case where the short range sensor 140 detects that an item is mounted on the forklift 220, the omnidirectional imaging device 130 captures an image of the item mounted on the forklift 220, and thus the item during transport is identified. FIG. 3 gives the example where the item identified with the identifier=“ID003” is during transport.

In the “positional information”, the 3D coordinates indicating the current position of the omnidirectional imaging device 130 calculated from the captured image of the markers 231 to 233 installed on the ceiling of the warehouse 210 are recorded in association with the item during transport. The 3D coordinates recorded in the “positional information” are updated in the predetermined cycles.

In the example of FIG. 3, since the item during transport is the item identified with the identifier=“ID003”, the calculated 3D coordinates are recorded in association with the identifier=“ID003”. In the example of FIG. 3, the forklift 220 to which the omnidirectional imaging device 130 is attached is currently at the position identified with the positional information=“(xₙ, yₙ, zₙ)” and is transporting the item identified with the identifier=“ID003”.

In the “storage place”, the 3D coordinates indicating the position in the warehouse 210 at which the item identified with the identifier recorded in the warehousing result is stored are recorded. As the 3D coordinates recorded in the “storage place”, recorded is the “positional information” at the time when the “transport flag” is changed from “ON” to “OFF” (in other words, when the item mounted on the forklift 220 is stored into the storage place).

FIG. 3 gives the example where the item identified with the identifier=“ID001” is already stored at the position identified with (x₁, y₁, z₁).

<Inventory Management Processing Sequence in Management System>

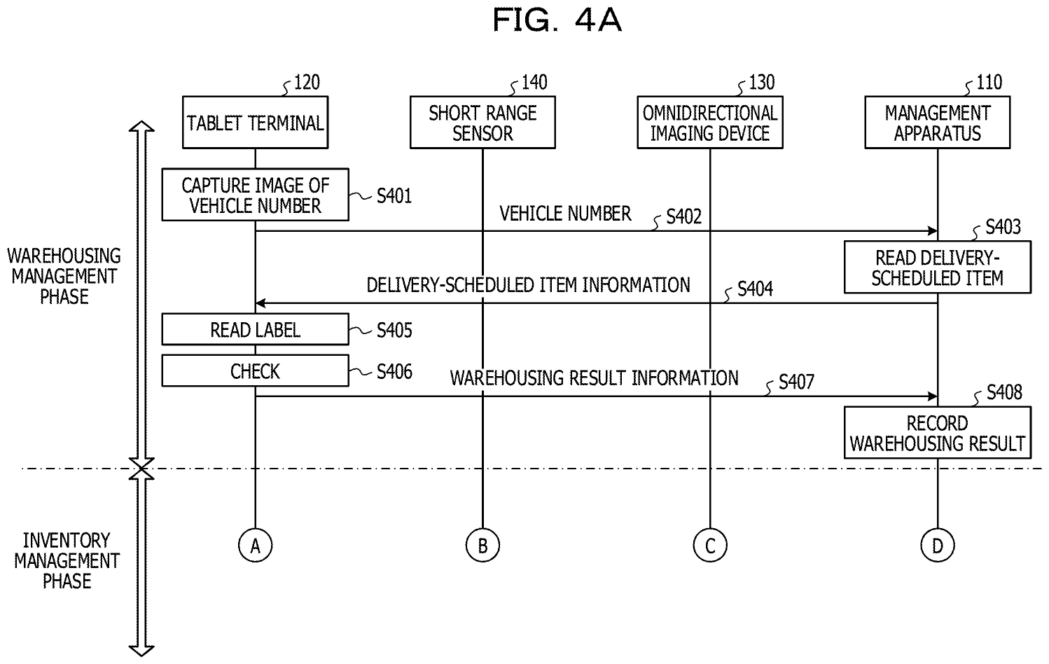

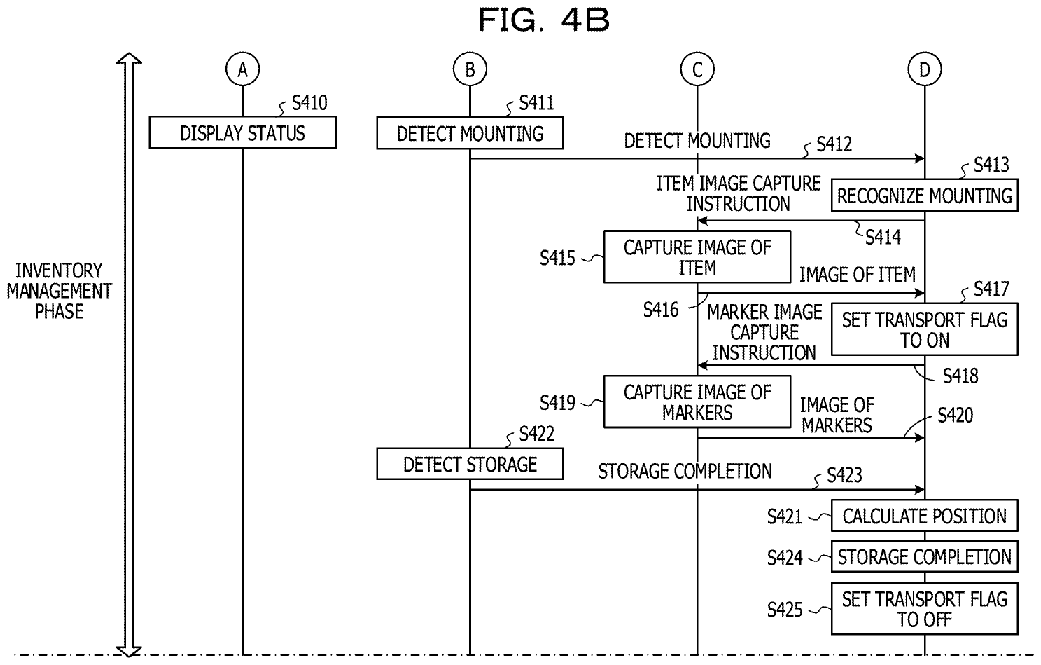

Next, detailed description is provided for an inventory management processing sequence in the management system 100. FIG. 4 is a sequence diagram illustrating an inventory management processing sequence in the management system. As illustrated in FIG. 4, when the warehousing management phase starts, the tablet terminal 120 captures an image of the number plate of the truck 201, which arrives at the warehouse 210, in step S401.

In step S402, the tablet terminal 120 transmits the captured image of the number plate to the management apparatus 110. In step S403, the management apparatus 110 analyzes the captured image of the number plate to identify the vehicle number of the truck 201, and reads the identifiers of the “delivery-scheduled items” associated with the vehicle number in reference to the management data 300 in the management data storage unit 113.

In step S404, the management apparatus 110 transmits the read identifiers as the delivery-scheduled item information to the tablet terminal 120.

In step S405, the tablet terminal 120 captures images of the labels attached to the items unloaded from the truck 201.

In step S406, the tablet terminal 120 checks the items identified with the captured images of the labels against the delivery-scheduled item information and thereby generates the warehousing result information specifying the items actually delivered.

In step S407, the tablet terminal 120 transmits the generated warehousing result information to the management apparatus 110.

In step S408, the management apparatus 110 records the transmitted warehousing result information in the “warehousing result” in the management data 300 stored in the management data storage unit 113. Thus, the warehousing management phase is completed, and the inventory management transitions to the inventory management phase.

When the inventory management phase starts, the tablet terminal 120 starts status display in step S410. In the status display, the tablet terminal 120 communicating with the management apparatus 110 displays, from moment to moment, whether the management apparatus 110 completes the execution of each of the below-described processes and various kinds of information acquired by the management apparatus 110 in the inventory management phase.

In step S411, the short range sensor 140 detects that an item is mounted on the forklift 220. In step S412, the short range sensor 140 notifies the management apparatus 110 that the mounting of the item is detected.

In step S413, the management apparatus 110 recognizes that the item is mounted on the forklift 220 by being notified by the short range sensor 140 that the mounting is detected. In addition, in step S424, the management apparatus 110 transmits an item image capture instruction to the omnidirectional imaging device 130.

The omnidirectional imaging device 130 having received the item image capture instruction captures an image of the item mounted on the forklift 220 in step S415. In step S416, the omnidirectional imaging device 130 transmits the captured image of the item to the management apparatus 110.

In step S417, the management apparatus 110 analyzes the captured image of the item to identify the item mounted on the forklift 220, and records “ON” in the “transport flag” associated with the identified item in the management data 300.

In step S418, the management apparatus 110 transmits a marker image capture instruction to the omnidirectional imaging device 130.

In step S419, the omnidirectional imaging device 130 having received the marker image capture instruction starts to capture an image of the markers 231 to 233 installed on the ceiling of the warehouse 210. The omnidirectional imaging device 130 captures the image of the markers in the predetermined cycles.

In step S420, the omnidirectional imaging device 130 transmits the captured image of the markers 231 to 233 to the management apparatus 110. The omnidirectional imaging device 130 transmits the captured image of the markers 231 to 233 to the management apparatus 110 in the predetermined cycles.

In step S421, the management apparatus 110 detects the markers 231 to 233 from the captured image of the markers 231 to 233. Then, the management apparatus 110 calculates the directions of the markers 231 to 233 with respect to the current position of the omnidirectional imaging device 130 based on the positions of the detected markers 231 to 233 in the captured image. Moreover, the management apparatus 110 calculates the 3D coordinates indicating the current position of the omnidirectional imaging device 130 based on the calculated directions of the markers 231 to 233 and the distances between the markers 231 to 233.

Here, the processes in steps S419 to S421 are iterated after an item is mounted on the forklift 220 until the item is stored into a predetermined storage place.

In step S422, the short range sensor 140 detects that the item mounted on the forklift 220 is stored in the predetermined storage place, and the mount position on the forklift 220 becomes empty.

In step S423, the short range sensor 140 notifies the management apparatus 110 that the storage of the item is completed.

In step S424, in response to the notification that the item is stored from the short range sensor 140, the management apparatus 110 changes the “transport flag” in the management data 300 from “ON” to “OFF”.

In step S425, the management apparatus 110 records, in the “storage place”, the 3D coordinates recorded in the “positional information” at the time when the “transport flag” is changed from “ON” to “OFF”. Thus, the storage place of the item is recorded, and therefore the inventory management phase ends. Note that, the processes in the inventory management phase are executed every time an item is mounted on the forklift 220.

<Hardware Configuration of Management Apparatus>

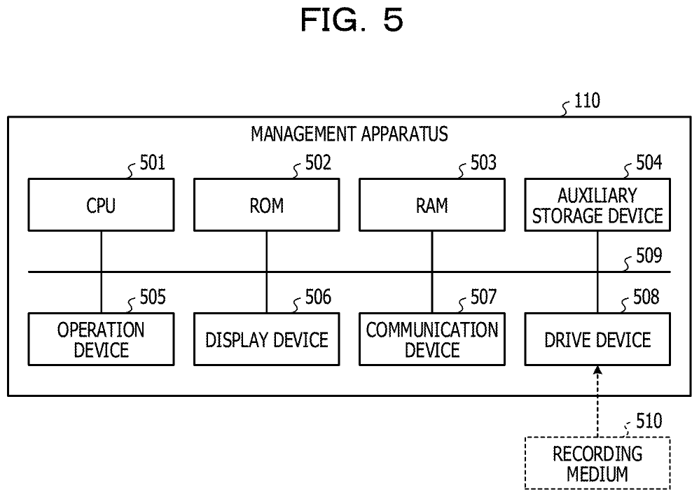

Next, a hardware configuration of the management apparatus 110 is described. FIG. 5 is a diagram illustrating one example of a hardware configuration of a management apparatus. As illustrated in FIG. 5, the management apparatus 110 includes a central processing unit (CPU) 501, a read only memory (ROM) 502, and a random access memory (RAM) 503. The CPU 501, the ROM 502, and the RAM 503 form a so-called computer.

Moreover, the management apparatus 110 includes an auxiliary storage device 504, an operation device 505, a display device 506, a communication device 507, and a drive device 508. Here, the hardware components of the management apparatus 110 are coupled to each other via a bus 509.

The CPU 501 is a device that runs various programs installed in the auxiliary storage device 504 (for example, a warehousing management program, an inventory management program, and so on).

The ROM 502 is a non-volatile memory. The ROM 502 functions as a main storage device which stores various programs, data, and so on to be used by the CPU 501 to run the various programs installed in the auxiliary storage device 504. Specifically, the ROM 502 functions as the main storage device which stores a boot program and so on such as a Basic Input/Output System (BIOS) and an Extensible Firmware Interface (EFI).

The RAM 503 is a volatile memory such as a dynamic random access memory (DRAM) or a static random access memory (SRAM). The RAM 503 functions as a main storage device which provides a work area on which the various programs installed in the auxiliary storage device 504 are expanded for execution by the CPU 501.

The auxiliary storage device 504 is an auxiliary storage device which stores the various programs and information to be used for execution of the various programs. For example, the management data storage unit 113 is implemented by the auxiliary storage device 504.

The operation device 505 is an operation device to be used by an administrator of the management apparatus 110 to input various instructions to the management apparatus 110. The display device 506 is a display device which displays an internal state of the management apparatus 110.

The communication device 507 is a communication device which is coupled to and communicates with the tablet terminal 120, the omnidirectional imaging device 130, and the short range sensor 140 via the network 150.

The drive device 508 is a device in which a recording medium 510 is set. The recording media 510 discussed herein include media which record information optically, electrically, and magnetically like a CD-ROM, a flexible disk, a magnetooptical disk, and so forth. In addition, the recording media 510 may also include a semiconductor memory and so on, such as a ROM and a flash memory, which record information electrically.

Here, the various programs installed in the auxiliary storage device 504 are installed, for example, in such a way that a distributed recording medium 510 is set in the drive device 508, and the various programs recorded in the recording medium 510 is read by the drive device 508. Alternatively, the various programs installed in the auxiliary storage device 504 may be installed by downloading the programs from the network through the communication device 507.

<Functional Configuration of Management Apparatus>

Next, detailed description is provided for functional configurations of the management apparatus 110 (the functional configurations of the warehousing manager 111 and the inventory manager 112).

(1) Detailed Functional Configuration of Warehousing Manager

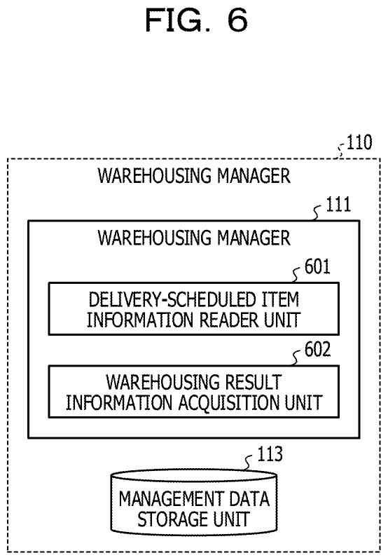

FIG. 6 is a diagram illustrating one example of a functional configuration of a warehousing manager in the management apparatus. As illustrated in FIG. 6, the warehousing manager 111 includes a delivery-scheduled item information reader unit 601 and a warehousing result information acquisition unit 602.

The delivery-scheduled item information reader unit 601 receives and analyzes the captured image of the number plate of the truck 201 to identify the vehicle number of the truck 201. Then, the delivery-scheduled item information reader unit 601 refers to the management data 300 stored in the management data storage unit 113 based on the identified vehicle number, and thereby reads the identifiers in the “delivery-scheduled item information” associated with the vehicle number. Moreover, the delivery-scheduled item information reader unit 601 transmits the read identifiers as the delivery-scheduled item information to the tablet terminal 120.

The warehousing result information acquisition unit 602 receives the warehousing result information from the tablet terminal 120, and records the warehousing result information in the “warehousing result” in the management data 300 stored in the management data storage unit 113.

(2) Detailed Functional Configuration of Inventory Manager

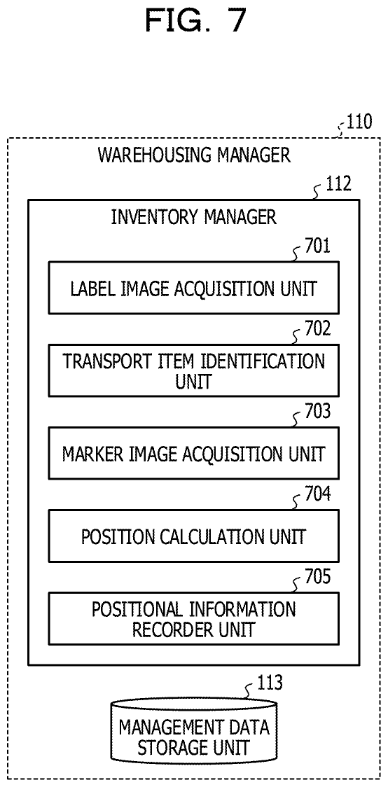

FIG. 7 is a diagram illustrating one example of a functional configuration of an inventory manager in the management apparatus. As illustrated in FIG. 7, the inventory manager 112 includes a label image acquisition unit 701, a transport item identification unit 702, a marker image acquisition unit 703, a position calculation unit 704, and a positional information recorder unit 705.

The label image acquisition unit 701 is one example of a second acquisition unit. When the short range sensor 140 detects that an item is mounted, the label image acquisition unit 701 recognizes that the item is mounted, and instructs the omnidirectional imaging device 130 to capture an image of the item mounted on the forklift 220.

Then, the label image acquisition unit 701 receives the captured image of the item from the omnidirectional imaging device 130 as a response to the instruction to capture the image of the mounted item, and transmits the received captured image to the transport item identification unit 702.

The transport item identification unit 702 is one example of an identification unit. The transport item identification unit 702 identifies the item mounted on the forklift 220 by analyzing the captured image of the item, and records “ON” in the “transport flag” associated with the identified item in the management data 300.

The marker image acquisition unit 703 is one example of an acquisition unit or a first acquisition unit. When “ON” is recorded in the “transport flag” in the management data 300, the marker image acquisition unit 703 instructs the omnidirectional imaging device 130 to capture an image of the markers 231 to 233. Then, the marker image acquisition unit 703 receives the captured image of the markers 231 to 233 from the omnidirectional imaging device 130 as a response to the instruction to capture the image of the markers 231 to 233, and transmits the received captured image to the position calculation unit 704.

The position calculation unit 704 is one example of a calculation unit. The position calculation unit 704 detects the markers 231 to 233 in the captured image of the markers 231 to 233. In addition, the position calculation unit 704 calculates the directions of the markers 231 to 233 with respect to the current position of the omnidirectional imaging device 130 based on the positions of the detected markers 231 to 233 in the captured image. Moreover, the position calculation unit 704 calculates the 3D coordinates indicating the current position of the omnidirectional imaging device 130 based on the calculated directions of the markers 231 to 233 and the distances between the markers 231 to 233. Further, every time the 3D coordinates are calculated, the position calculation unit 704 records the calculated 3D coordinates in the “positional information” in the management data 300 stored in the management data storage unit 113.

The positional information recorder unit 705 is one example of a recorder unit. In response to a notification of completion of the storage from the short range sensor 140, the positional information recorder unit 705 changes the “transport flag” in the management data 300 from “ON” to “OFF”. Moreover, the positional information recorder unit 705 records, in the “storage place”, the 3D coordinates recorded in the “positional information” at the time when the “transport flag” is changed from “ON” to “OFF”.

Use of the captured images obtained by the omnidirectional imaging device 130 to identify the item and calculate the 3D coordinates as described above enables the inventory management of items with low cost.

<Description of 3D Coordinates Calculation Method by Position Calculation Unit>

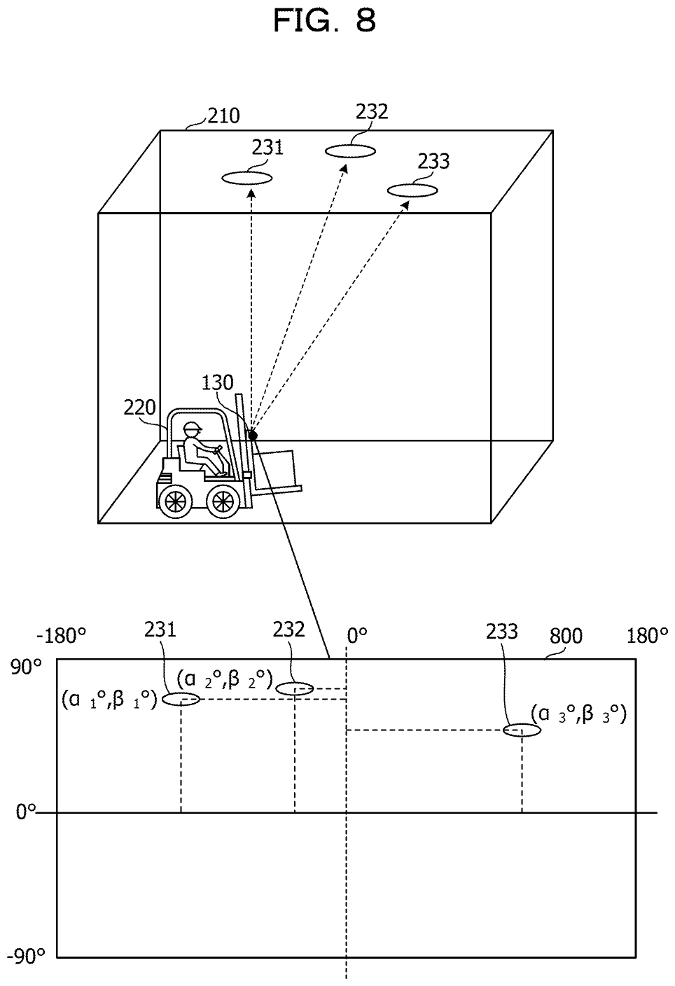

Next, description is provided for a method of calculating the 3D coordinates indicating the current position of the omnidirectional imaging device 130 by the position calculation unit 704. FIG. 8 is a first diagram illustrating a method of calculating three dimensional coordinates by a position calculation unit.

As illustrated in FIG. 8, the omnidirectional imaging device 130 attached to the lifting device of the forklift 220 captures an image of the markers 231 to 233 installed on the ceiling of the warehouse 210 iteratively in predetermined cycles while the forklift 220 mounted with the item is transporting the item.

A captured image 800 is one example of a captured image of the markers 231 to 233. As illustrated in FIG. 8, the position of each pixel in the captured image 800 is associated with an azimuth angle and an elevation angle (depression angle) with respect to the omnidirectional imaging device 130 as a reference position (an azimuth angle=0° and an elevation angle=0°). Thus, by detecting the positions of the markers 231 to 233 in the captured image 800, the position calculation unit 704 is capable of calculating the azimuth angle and the elevation angle (depression angle) of each of the markers 231 to 233 with respect to the omnidirectional imaging device 130.

In the example of FIG. 8, the horizontal axis indicates an azimuth angle and the vertical axis indicates an elevation angle (depression angle). For example, the direction of the marker 231 with respect to the omnidirectional imaging device 130 is calculated as an azimuth angle=α₁° and an elevation angle=β₁° from the center position of the marker 231 in the captured image 800. Then, the direction of the marker 232 with respect to the omnidirectional imaging device 130 is calculated as an azimuth angle=α₂° and an elevation angle=β₂° from the center position of the marker 232 in the captured image 800. Moreover, the direction of the marker 233 with respect to the omnidirectional imaging device 130 is calculated as an azimuth angle=α₃° and an elevation angle=β₃° from the center position of the marker 233 in the captured image 800.

By calculating the directions of the markers 231 to 233 with respect to the omnidirectional imaging device 130, the position calculation unit 704 calculates the 3D coordinates of the omnidirectional imaging device 130 based on the known distances between the markers 231 to 233.

Here, the 3D coordinates of each position in the warehouse 210 are defined in advance, and the 3D coordinates of each of the markers 231 to 233 are also defined in advance. Thus, once the positional relationship among the markers 231 to 233 and the omnidirectional imaging device 130 is determined, it is possible to calculate the 3D coordinates indicating the position of the omnidirectional imaging device 130 in the warehouse 210.

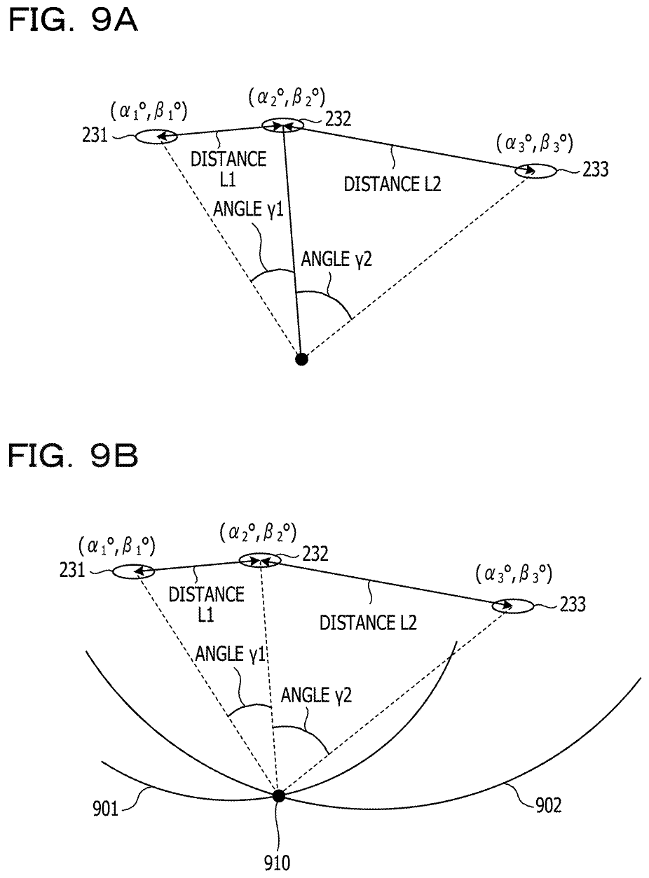

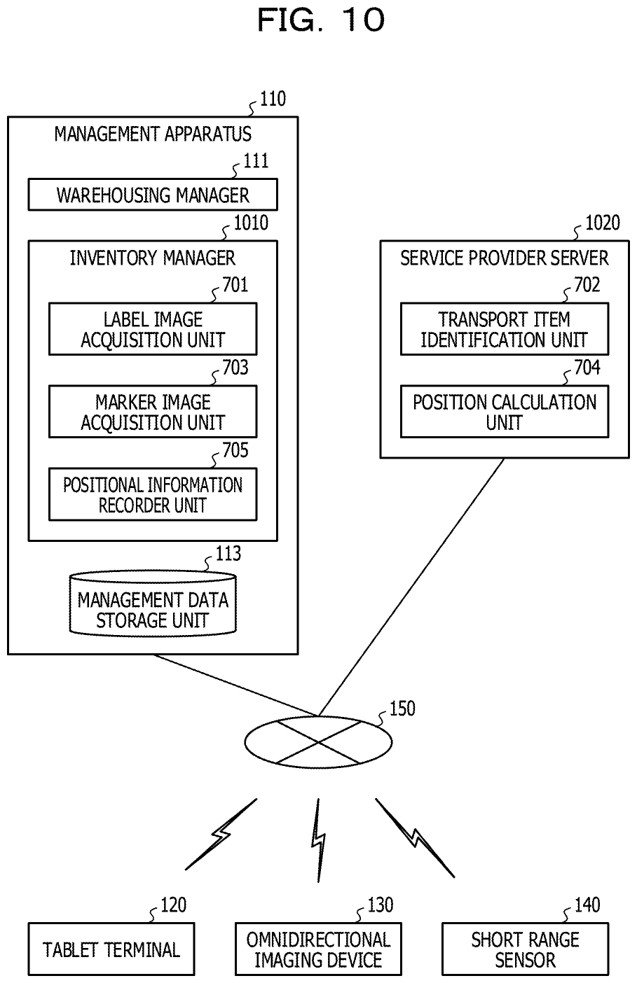

FIGS. 9A and 9B are second diagrams illustrating the method of calculating the three dimensional coordinates by the position calculation unit. As illustrated in FIG. 9A, from a difference between the direction of the marker 231 (the azimuth angle=α₁° and the elevation angle=β₁° and the direction of the marker 232 (the azimuth angle=α₂° and the elevation angle=β₂°, the position calculation unit 704 calculates an angle γ1 between the direction of the marker 231 and the direction of the marker 232.

Similarly, from a difference between the direction of the marker 232 (the azimuth angle=α₂° and the elevation angle=β₂° and the direction of the marker 233 (the azimuth angle=α₃° and the elevation angle=β₃°, the position calculation unit 704 calculates an angle γ2 between the direction of the marker 232 and the direction of the marker 233.

Here, as illustrated in FIG. 9B, a position at which the difference between the directions of the markers 231 and 232 is the angle γ1 and the distance between the markers 231 and 232 is L1 lies at any point on an arc 901. In addition, a position at which the difference between the directions of the markers 232 and 233 is the angle γ2 and the distance between the markers 232 and 233 is L2 lies at any point on an arc 902.

Therefore, the position calculation unit 704 determines the positional relationship among the markers 231 to 233 and the omnidirectional imaging device 130 by obtaining a point 910 at which the arc 901 and the arc 902 intersect each other. As a result, the position calculation unit 704 is capable of calculating the 3D coordinates indicating the position of the omnidirectional imaging device 130 in the warehouse 210.

By using the captured image 800 as described above, an error in calculating the 3D coordinates may be restricted to a resolution level of the omnidirectional imaging device 130 (an error by an actual distance corresponding to one pixel in the captured image 800). This leads to an improvement of the calculation accuracy. In addition, the use of the captured image 800 enables the low-cost calculation of the 3D coordinates.

### Conclusion

As is clear from the foregoing description, in the first embodiment, the management apparatus 110 acquires the captured image that the omnidirectional imaging device attached to the forklift obtains by photographing the three markers installed on the ceiling of the warehouse and arranged at the known distances from each other. The management apparatus 110 calculates the directions of the markers with respect to the omnidirectional imaging device from the positions of the respective markers in the captured image. Then, the management apparatus 110 calculates the 3D coordinates indicating the current position of the omnidirectional imaging device (in other words, the 3D coordinates indicating the current position of the forklift to which the omnidirectional imaging device is attached) based on the calculated directions of the markers and the known distances between the markers.

By using the captured image as described above, the management apparatus 110 is capable of improving the calculation accuracy in calculating the position of the forklift which is moving inside the warehouse. In addition, the low-cost position calculation is achieved.

Moreover, in the first embodiment, the management apparatus 110 acquires the captured image that the omnidirectional imaging device obtains by photographing the label of the item mounted on the forklift. Then, the management apparatus 110 identifies the item mounted on the forklift by analyzing the acquired captured image.

Thus, the management apparatus 110 is capable of achieving low-cost management of the position of an item being transported by the forklift and the storage places of items stored. In short, the management apparatus 110 is capable of achieving the inventory management of items with high accuracy and low cost.

### Second Embodiment

The above first embodiment is described for the case where all of the functions of the warehousing manager 111 and the inventory manager 112 are implemented by the management apparatus 110. However, some of the functions of the warehousing manager 111 and the inventory manager 112 may be implemented by an apparatus other than the management apparatus 110 (for example, an apparatus on a cloud). Hereinafter, a second embodiment is described mainly in terms of the differences from the aforementioned first embodiment.

<System Configuration of Management System>

FIG. 10 is a diagram illustrating another example of the system configuration of the management system. A management system 1000 according to the second embodiment illustrated in FIG. 10 has a system configuration different from the system configuration described using FIG. 1 in that the management system 1000 includes a service provider server 1020 and the service provider server 1020 implements some of the functions of the inventory manager.

As illustrated in FIG. 10, an inventory management program is installed in the management apparatus 110, and the management apparatus 110 functions as an inventory manager 1010 by running the program. In the present embodiment, the inventory manager 1010 includes a label image acquisition unit 701, a marker image acquisition unit 703, and a positional information recorder unit 705.

Meanwhile, a transport item identification program and a position calculation program are installed in the service provider server 1020, and the service provider server 1020 functions as a transport item identification unit 702 and a position calculation unit 704.

Every time the service provider server 1020 receives a captured image of an item from the management apparatus 110, the service provider server 1020 analyzes the received captured image and identifies the item mounted on the forklift. Thus, the service provider server 1020 is capable of providing information on the identified item to the management apparatus 110.

In addition, every time the service provider server 1020 receives a captured image of the markers 231 to 233 from the management apparatus 110, the service provider server 1020 calculates the 3D coordinates indicating the current position of the omnidirectional imaging device 130. Thus, the service provider server 1020 is capable of providing the calculated 3D coordinates to the management apparatus 110.

### Conclusion

As is clear from the foregoing description, in the second embodiment, the service provider server 1020 acquires, from the management apparatus, the captured image that the omnidirectional imaging device attached to the forklift obtains by photographing the three markers installed on the ceiling of the warehouse and arranged at the known distances from each other. The service provider server 1020 calculates the directions of the markers with respect to the omnidirectional imaging device from the positions of the respective markers in the captured image. Then, the service provider server 1020 calculates the 3D coordinates indicating the current position of the omnidirectional imaging device (in other words, the 3D coordinates indicating the current position of the forklift to which the omnidirectional imaging device is attached) based on the calculated directions of the markers and the known distances between the markers, and transmits the 3D coordinates to the management apparatus.

Thus, the service provider server 1020 is capable of improving the calculation accuracy in calculating the position of the forklift which is moving inside the warehouse and providing the calculated position to the management apparatus.

### OTHER EMBODIMENTS

The above first and second embodiments are described for the case where the omnidirectional imaging device 130 is attached to the forklift. However, the mobile object to which the omnidirectional imaging device 130 is attached is not limited to the forklift. For example, the omnidirectional imaging device 130 may be attached to any mobile object (for example, a dolly, a crane, a tractor, a drone, and a person) as long as the mobile object moves inside a building.

In addition, the above first and second embodiments are described for the case where the positions of an item in the transport operation and in the storage operation are managed by calculating the 3D coordinates of the mobile object. However, the usage of the calculated 3D coordinates is not limited to the above embodiments, but may be usage other than the inventory management. For example, the calculated 3D coordinates may be used to control operations of a mobile object.

Moreover, the above first and second embodiments are described for the case where the markers 231 to 233 are installed on the ceiling of the warehouse. However, the installation places of the markers 231 to 233 are not limited to the ceiling. The markers may be installed in any places within a range where the omnidirectional imaging device 130 attached to the mobile object is capable of capturing images.

Further, the above first and second embodiments are described for the case where the three markers 231 to 233 are installed. However, the number of markers installed may be any number of 3 or more.

Furthermore, the above first and second embodiments are described for the case where the targets, the image of which is captured by the omnidirectional imaging device 130, are the markers. However, the targets are not limited to the markers. For example, any particular objects installed in the warehouse (objects having characteristics based on which the objects are extractable by analyzing the captured image) may be used as targets, as long as the distances between the objects are known.

Still further, the above first and second embodiments are described for the case where an item is identified based on a label attached to the item. However, the method of identifying an item is not limited to this. For example, an item may be identified based on a barcode attached to the item. Alternatively, an item may be identified based on a shape of the item.

Still furthermore, the above first and second embodiments are described for the case where the 3D coordinates are recorded in the “storage place” in the management data 300 stored in the management data storage unit 113. However, information recorded in the “storage place” is not limited to the 3D coordinates. Any information other than the 3D coordinates may be used as long as the information specifies a position in the warehouse 210.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management system comprising:
a management apparatus; and
an imaging device which is attached to a mobile object moving inside a building and which is coupled to the management apparatus, wherein
the management apparatus
acquires a captured image which the imaging device attached to the mobile object obtains by photographing at least three targets installed on a ceiling of the building and arranged at known distances from each other, and
calculates a position of the mobile object to which the imaging device is attached based on positions of the targets in the captured image and the distances between the targets.

2. The management system according to claim 1, further comprising:
a sensor which detects that an item is mounted on the mobile object, wherein
in a case where the sensor detects that an item is mounted on the mobile object, the management apparatus
acquires a captured image which the imaging device obtains by photographing the item mounted on the mobile object,
identifies the item mounted on the mobile object based on the acquired captured image, and
records, as a storage place of the identified item, the position calculated at a time when the identified item is stored by the mobile object.

3. The management system according to claim 1, further comprising:
a terminal coupled to the management apparatus, wherein
the management apparatus
stores information identifying an item scheduled to be loaded on a vehicle in a storage unit while associating the information with a number of the vehicle,
acquires a captured image of a number plate of a vehicle from the terminal,
identifies the number of the vehicle based on the acquired captured image, and
transmits the information identifying the item scheduled to be loaded on the vehicle to the terminal, the information stored in the storage unit while being associated with the identified number of the vehicle.

4. The management system according to claim 3, wherein
as a response to the transmission of the information identifying the item scheduled to be loaded on the vehicle to the terminal, the management apparatus acquires warehousing result information specifying an item actually delivered from the terminal.

5. A non-transitory computer-readable storage medium storing a program that causes a processor included in a computer to execute a process, the process comprising:
acquiring a captured image which an imaging device attached to a mobile object obtains by photographing at least three targets arranged at known distances from each other; and
calculating a position of the mobile object to which the imaging device is attached based on positions of the targets in the captured image and the distances between the targets.

6. A management apparatus comprising:
a memory; and
a processor coupled to the memory and configured to:
acquire a captured image which an imaging device attached to a mobile object obtains by photographing at least three targets arranged at known distances from each other; and
calculate a position of the mobile object to which the imaging device is attached based on positions of the targets in the captured image and the distances between the targets.

7. The management apparatus to claim 7, wherein
the processor
acquires a captured image which the imaging device obtains by photographing an item mounted on the mobile object,
identifies the item mounted on the mobile object based on the acquired captured image, and
records, as a storage place of the identified item, the position calculated at a time when the identified item is stored by the mobile object.
